(19) United States
(12) Patent Application Publication
(10) Pub. No.: US 2026/0142919 A1
(43) Pub. Date: May 21, 2026

(54) Systems and Methods for Dynamic Traffic Routing

(71) Applicant: Zscaler, Inc., San Jose, CA (US)

(72) Inventors: Anirudh Achanta, San Jose, CA (US); Pankaj Chhabra, Burnaby (CA); Ailin Saggau-Lyons, Vancouver (CA); Prasannakumar Jobigenahally Malleshaiah, San Jose, CA (US); Shreyas Madapura Chandraiah, San Jose, CA (US); Francisco Javier Rodriguez Gonzalez, San Jose, CA (US); Surender Singh, San Jose, CA (US); Amber Wu, San Jose, CA (US)

(73) Assignee: Zscaler, Inc., San Jose, CA (US)

(21) Appl. No.: 19/012,592

(22) Filed: Jan. 7, 2025

(30) Foreign Application Priority Data
Nov. 21, 2024 (IN) 202441090527

(51) Int. Cl. H04L 45/00; H04L 43/065; H04L 45/24

(52) U.S. Cl. CPC H04L 45/70; H04L 43/065; H04L 45/24

(57) ABSTRACT

Systems and methods for dynamic traffic routing include monitoring connectivity to a plurality of available Data Centers (DCs) associated with a cloud-based system; generating real-time connectivity information based on the monitoring, the real-time connectivity information including a performance level of the plurality of available DCs; determining a best performing DC from the plurality of available DCs; and switching a connection from a current DC to the best performing DC.

### FIELD OF THE DISCLOSURE

The present disclosure generally relates to network and cloud security. More particularly, the present disclosure relates to systems and methods for dynamic traffic routing.

### BACKGROUND OF THE DISCLOSURE

Collecting and visualizing network traffic metrics through a cloud system presents several challenges. Monitoring traffic across distributed cloud environments involves handling vast amounts of data in real time, which can strain resources and increase latency. Network data often originates from multiple sources, such as virtual machines, containers, or cloud services, making it difficult to aggregate and correlate effectively. Additionally, maintaining visibility across different cloud providers or hybrid environments can be complex, as each platform may use unique formats or metrics. Visualizing this data further requires powerful tools that can process and present insights clearly, but ensuring dashboards remain responsive under heavy data loads can be difficult. Together, these challenges complicate the collection, processing, and visualization of network metrics in cloud-based systems.

### BRIEF SUMMARY OF THE DISCLOSURE

The present disclosure relates to systems and methods for dynamic traffic routing. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include monitoring connectivity to a plurality of available Data Centers (DCs) associated with a cloud-based system; generating real-time connectivity information based on the monitoring, the real-time connectivity information including a performance level of the plurality of available DCs; determining a best performing DC from the plurality of available DCs; and switching a connection from a current DC to the best performing DC.

The steps can further include wherein the monitoring, generating, determining, and switching are performed by an agent application on a computing device, and wherein the switching includes forwarding traffic from the computing device to the cloud-based system via the best performing DC. The determining can include augmenting real-time connectivity information with historical performance data of each DC. The steps can include generating performance baselines by the hour for every day of the week for each of the plurality of available DCs. The steps can include dynamically updating the performance baselines based on real-time data. Determining a best performing DC can be based on the performance baselines and real-time connectivity information of the plurality of available DCs. The switching can include delaying the switching by a preconfigured interval to mitigate the impact of transient connection performance fluctuations. The switching can include remaining connected to a DC for a predetermined duration, thereby preventing frequent switches even if a better path is identified during this period.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a screenshot of a graphical visualization generated by the present systems.

FIG. 6 is a flowchart of a process for providing detailed cloud-level network traffic visualizations.

FIG. 7 is a flow diagram of the dynamic traffic routing.

FIG. 8 is a flowchart of a process for dynamic traffic routing.

FIG. 9 is a screenshot of the dashboard displaying a comprehensive view of network performance across different regions.

FIG. 10 is a screenshot of the dashboard displaying ISP performance rankings.

FIG. 11 is a flowchart of a process for providing an ISP ranking dashboard.

### DETAILED DESCRIPTION OF THE DISCLOSURE

Again, the present disclosure relates to systems and methods for providing detailed cloud-level network traffic visualizations. The system employs sophisticated analytics and machine learning algorithms to process and interpret vast amounts of network performance data. These advanced techniques enable the system to detect patterns and anomalies that may indicate underlying issues. This data is then visualized by generating various tenant-specific graphs for allowing tenants of the cloud-based system to quickly determine and remediate any network issues.

Additionally, the present disclosure relates to systems and methods for dynamic traffic routing. The systems and methods include monitoring network metrics and automatically switching a user to a more performant data center using both real-time and historical baseline network data. Based on the capability of an agent application to switch between data centers (DCs), a system is introduced that automates this process to ensure optimal performance. To achieve this, the application is adapted to periodically monitor its connectivity to a set of available DCs. This monitoring generates real-time connectivity information regarding the performance of each of the DCs. Based on this real-time data the application can select to switch to the best performing DC.

Additionally, the present disclosure relates to systems and methods for providing customized internet service provider (ISP) ranking dashboards. Ensuring optimal internet performance is crucial for organizations and their users'satisfaction. However, selecting the best ISP remains a significant challenge due to the lack of personalized, geolocation-specific data. To address this issue, an advanced dashboard that equips organizations with real-time updates on network health and offers a comprehensive comparison of ISPs based on geolocation is introduced. By leveraging this sophisticated tool, organizations can make well-informed decisions, ensuring they achieve the highest possible internet service quality tailored to their specific needs. This innovative solution not only enhances efficiency but also empowers organizations to maintain a competitive edge in an increasingly connected world.

### § 1.0 Cybersecurity Monitoring and Protection Examples

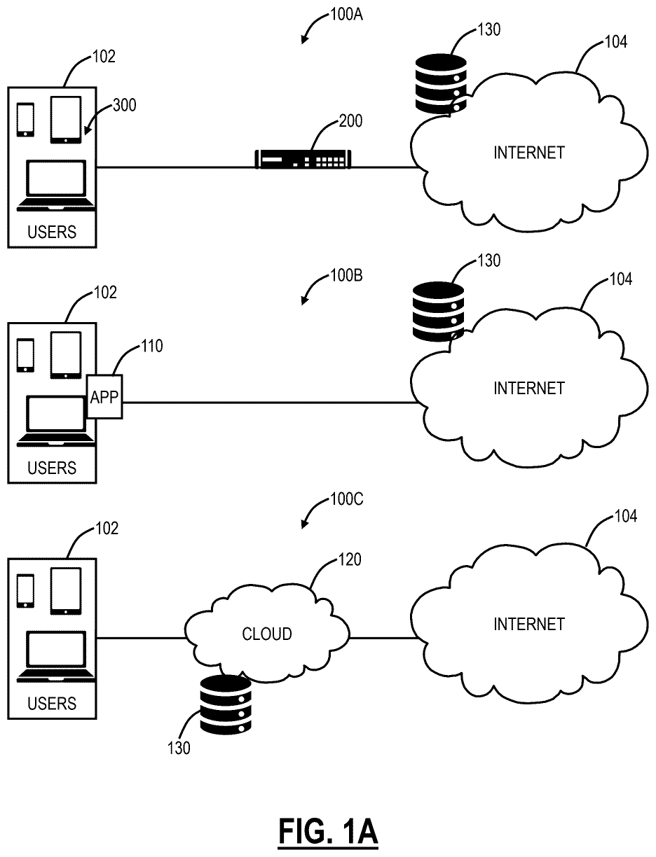

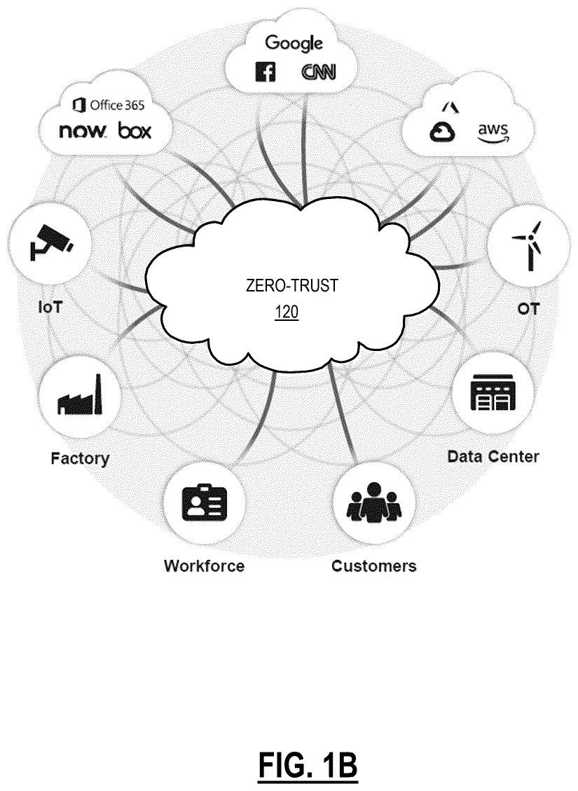

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

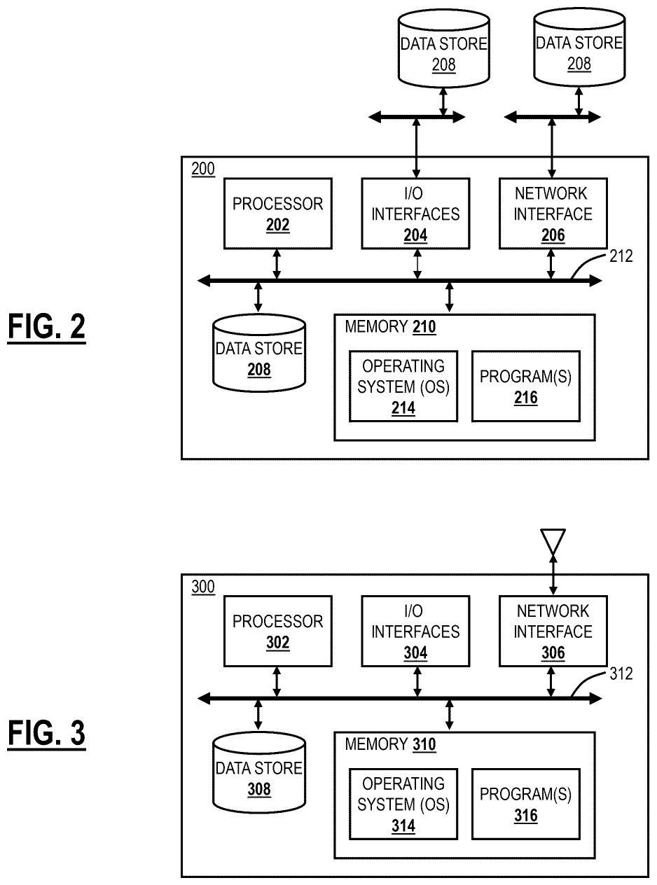

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:
Commonly-assigned U.S. Pat. No. 8,429,111, issued Apr. 23, 2013, and entitled “Encoding and compression of statistical data,” the contents of which are incorporated herein by reference, describes compression techniques for storing such logs,
Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and
Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc..

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

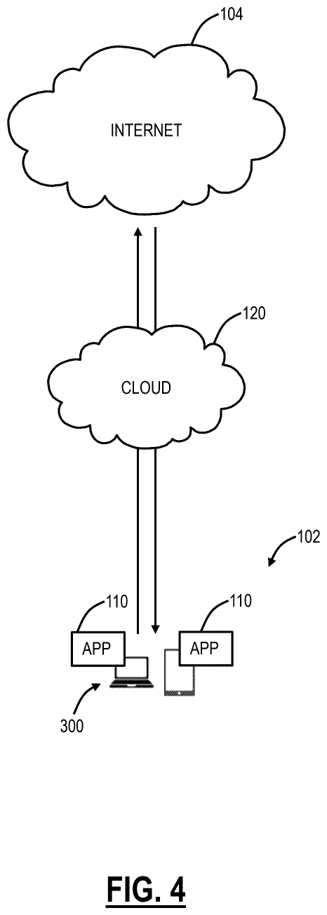

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Digital Experience Monitoring

The cloud 120 is adapted to perform digital experience monitoring (ZDX), an advanced solution designed to enhance the digital experience of users by providing comprehensive visibility and insights into application, network, and device performance. This service operates by continuously measuring and analyzing key performance metrics across the entire service delivery path, from the user endpoint to the application hosted in the cloud or data center. By leveraging the extensive global cloud infrastructure, digital experience monitoring can correlate data from various sources, including end-user devices, network paths, and application servers, to pinpoint performance bottlenecks and latency issues. This holistic approach allows IT teams to quickly identify and resolve problems that impact user experience, ensuring optimal performance for critical business applications. Digital experience monitoring also includes synthetic monitoring capabilities, which simulate user interactions to proactively detect potential issues before they affect actual users. Furthermore, its integration with the broader Zero Trust Exchange platform of the cloud 120 ensures that security and performance are managed cohesively, providing a seamless and secure digital experience. Overall, digital experience monitoring empowers organizations to deliver superior user experiences by maintaining high performance and reliability of their digital services.

The digital experience monitoring system works by providing end-to-end visibility into the entire digital experience of users, from their devices to the applications they access. Below is a detailed breakdown of how the present digital experience monitoring systems operate.

Data Collection: Agents installed on user devices, i.e., the application 110, collect real-time data on device health, including CPU, memory, and disk usage. They also monitor network performance metrics such as latency, packet loss, and jitter. The system continuously monitors the network path between the user and the application, capturing data on every hop, including ISPs, proxies, and other network elements. This helps in identifying where latency or packet loss is occurring. The system tracks the performance of cloud and SaaS applications by measuring response times and transaction success rates, ensuring they are performing as expected.

Synthetic Monitoring: The system uses synthetic transactions to emulate user interactions with applications. These synthetic tests are conducted regularly to proactively identify potential issues in application performance before they impact real users.

Correlation and Analysis: The system correlates data from the endpoints, network paths, and applications to provide a comprehensive view of the digital experience. This correlation helps in identifying the root cause of performance issues, whether they originate from the user's device, the network, or the application itself. The system further leverages ML algorithms to analyze the collected data, detect anomalies, and predict potential issues. This proactive approach helps in preventing performance degradation.

Dashboards and Reporting: The system provides a centralized dashboard where IT teams can view detailed insights and metrics related to user experience. The dashboard includes visualizations of performance trends, real-time alerts, and historical data analysis. IT teams can generate custom reports to analyze specific aspects of digital experience, helping them to make informed decisions and prioritize remediation efforts.

Integration with Zscaler Zero Trust Exchange: The system integrates seamlessly with the Zero Trust Exchange, ensuring that security and performance are managed in tandem. This integration provides a holistic approach to maintaining secure and high-performing digital experiences.

Automated Remediation: The system includes capabilities for automated remediation, where predefined actions can be taken to address common issues. For example, if high latency is detected on a specific network path, The system can automatically reroute traffic through an alternative path to maintain optimal performance.

By combining real-time monitoring, synthetic testing, advanced analytics, and seamless integration with broader security platforms of the cloud 120, the digital experience monitoring system enables organizations to ensure that their users enjoy a consistently high-quality digital experience. This proactive and comprehensive approach not only enhances user satisfaction but also boosts overall productivity and operational efficiency.

### § 6.0 Network Traffic Analysis and Visualization

The present disclosure provides an Internet network intelligence system that harnesses the advanced capabilities of the cloud's 120 digital experience monitoring trace data to create an intricate and informative graphical representation of network traffic as it traverses across various geolocations. This state-of-the-art visualization tool translates complex and often convoluted network paths into clear, comprehensible visuals, greatly assisting network administrators, operations teams, and support personnel in their efforts to manage and maintain network infrastructure with heightened efficiency and effectiveness.

The power of this tool lies in its ability to expose the complexities of network routes, offering a view of how data flows through different nodes and regions. With this level of transparency, teams can swiftly identify bottlenecks, latency issues, and potential points of failure within the network. This granular insight is invaluable for diagnosing issues that could hinder network performance, allowing for quicker and more accurate troubleshooting.

Moreover, the present systems, tools, etc., which can be contemplated as being associated with the described digital experience monitoring system, enhances the monitoring capabilities of Information Technology (IT) teams, providing them with real-time data and historical trends that can be analyzed to predict and preempt network disruptions. By leveraging these predictive analytics, teams can implement proactive measures to mitigate risks before they escalate into critical problems, thereby reducing downtime and ensuring continuity of service.

The tool's sophisticated visual insights go beyond mere troubleshooting. They enable comprehensive network performance management by allowing teams to continuously assess and optimize the network's health and efficiency. This continuous monitoring and optimization lead to a more resilient and robust network infrastructure, capable of supporting the dynamic needs of modern enterprises.

Furthermore, the graphical representations generated by the system serve as an excellent communication tool. They provide a clear and intuitive way to convey network status and issues to stakeholders who may not have a deep technical background, fostering better understanding and collaboration across different departments. The system offers real-time identification of internet choke points across different regions, which empowers organizations to proactively optimize their network routes. This capability is crucial for maintaining efficient data flow and minimizing latency issues, thereby ensuring smooth and uninterrupted connectivity. Designed with a global scale in mind, the system provides unparalleled visibility into the performance of critical internet pathways. This expansive reach enables network administrators to monitor and manage their network infrastructure comprehensively, regardless of geographical boundaries.

One of the standout features of the system is its ability to accurately visualize the real data path. It traces the route from the user's device to the application, whether the path goes through the cloud 120 or directly to the application. This level of detail is instrumental in diagnosing and resolving network issues by providing a clear picture of the data journey.

Additionally, the system meticulously computes baselines and performs comparative analysis on each segment of the trace. This thorough evaluation ensures that performance analysis is both accurate and insightful, allowing teams to pinpoint inefficiencies and implement targeted improvements.

In today's dynamic and increasingly digital work environment, organizations face the challenge of managing a workforce that is widely dispersed across the globe. Employees operate from a variety of locations, including traditional office spaces, remote home offices, and even mobile settings. This geographical diversity means that employees are dependent on a range of Software-as-a-Service (SaaS) and private applications hosted in public or private clouds to perform their job functions efficiently and effectively.

The productivity of these employees is intricately linked to the responsiveness and seamless functionality of these applications. For example, a salesperson's ability to meet targets and close deals hinges on the flawless performance of Salesforce. Similarly, developers rely on a suite of tools, including GitHub, Bitbucket, Slack, and email, to collaborate on projects, write code, and manage workflows. Additionally, communication platforms such as Zoom and Microsoft Teams have become indispensable for the entire workforce, enabling real-time collaboration and communication across different time zones and regions.

The quality of the internet connection that employees use to access these cloud-hosted SaaS or private applications is a critical factor influencing their productivity and overall user experience. A poor or unstable internet connection can lead to significant disruptions, causing delays, reducing efficiency, and ultimately impacting the organization's bottom line. For infrastructure and IT teams, understanding the internet paths employees take to access these essential applications is crucial for managing and optimizing productivity. However, traditional methods of network monitoring, such as running traceroutes from a limited number of locations, provide only a narrow and often incomplete view of the network landscape. Alternatively, by utilizing the clouds 120 global reach and millions of connected devices, a much better understanding of network performance can be achieved.

This limitation poses a significant challenge for IT administrators, application owners, and infrastructure teams who need to identify and resolve network issues that adversely affect employee performance. A limited view makes it difficult to pinpoint the root causes of connectivity problems, leading to prolonged downtimes and reduced productivity. To overcome this challenge, the present disclosure provides a robust solution built on the clouds 120 digital experience monitoring systems (ZDX), which leverages an extensive global scale. The approach involves executing over 3 billion traces daily from tens of thousands of locations worldwide, spanning various Internet Service Providers (ISPs). This massive dataset provides unparalleled visibility into the internet paths and choke points that users encounter, offering a comprehensive and detailed understanding of the network landscape.

With the present systems, organizations gain the ability to monitor and analyze the real-time performance of internet connections from a multitude of global locations. This insight enables IT teams to identify potential bottlenecks and performance degradation points proactively. By understanding where and why these issues occur, organizations can implement targeted optimizations to improve network performance.

By leveraging the clouds global scale and comprehensive visibility, organizations can better manage network performance, swiftly address potential problems, and ensure that employees have reliable access to the critical applications they need to perform their jobs. This proactive approach not only enhances productivity but also improves the overall user experience, contributing to the seamless operation of business processes and the achievement of organizational goals.

In various embodiments, the present solution includes three main steps including data collection, data analysis, and visualization. The digital experience monitoring system captures traces every five minutes, or other interval, from a vast network of millions of devices spread across the globe. These traces contain detailed information about network paths, latency, packet loss, and other critical metrics required to assess network performance and health. The sheer volume and granularity of this data enable a thorough understanding of network behavior and trends, providing a robust foundation for performance analysis. This is only possible due to the amount of traffic that traverse the cloud 120.

Each captured trace meticulously records the path that data packets take from the user's device (computing devices 300) to the target application or server (destination). This includes every intermediate node or “hop” that the data traverses, along with precise measurements of latency and any packet loss occurring at each hop. By collecting this data continuously and at such a large scale, the digital experience monitoring system is able to create a comprehensive and dynamic map of global network performance.

The billions of traces collected from millions of devices are then meticulously analyzed to extract in-depth insights. This analysis is conducted at a geographical level to understand regional network performance and identify location-specific issues. By breaking down the data geographically, the system can pinpoint performance bottlenecks and latency issues that may be affecting users in specific regions or countries.

Each hop in the trace represents a segment of the traffic path between two IP addresses, which may belong to the same Internet Service Provider (ISP) or different ISPs. To accurately map the network path and understand various network entities, every IP address in the data is looked up to identify its corresponding ISP and Autonomous System Number (ASN). This detailed mapping is essential for understanding the contributions of different network segments to overall performance.

By grouping these hops based on ISPs, the system can evaluate both intra-ISP (within the same ISP) and inter-ISP (between different ISPs) performance. This allows the system to identify specific network segments that may be causing delays or packet loss, whether they are within a single ISP's network or at the interfaces between different ISPs. The analysis yields a comprehensive set of important metrics including, but not limited to, the following.

Number of probes: The total number of traces conducted.

Number of devices: The count of devices participating in the traces.

Percentile latencies (P33, P50, P66, P90, P99): These metrics provide a detailed view of latency distribution, helping to understand typical and worst-case performance.

Baselines: Standard performance metrics to compare against real-time data.

End-to-end loss and latency: Overall performance metrics from the source to the destination.

These metrics provide a detailed view of network performance from multiple perspectives, highlighting trends and pinpointing any issues in the network path. The granularity and breadth of this data enable IT teams to make informed decisions about network optimizations and to identify and resolve issues proactively.

By leveraging this extensive data collection and sophisticated analysis, organizations can significantly enhance their network performance management. The insights gained from the system allow for proactive identification and resolution of network issues, leading to improved application responsiveness and user experience. This comprehensive approach ensures that network performance is optimized, ultimately supporting higher productivity and seamless operation of business processes.

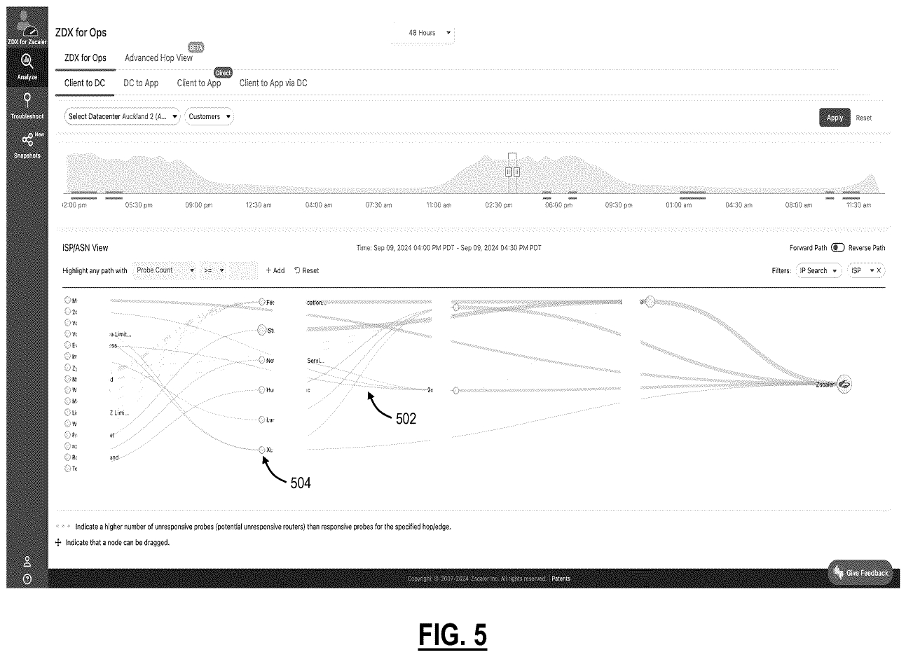

As described, visualization of this data is a key component of the present system. FIG. 5 is a screenshot of a graphical visualization generated by the present systems. Advanced visualization techniques are utilized to represent network performance primarily through links 502 and nodes 504, where nodes 504 symbolize ISPs and links 502 illustrate the paths between them. Latency serves as the primary performance indicator between these hops, with color codes based on latency measurements providing immediate visual cues. For example, red for poor performance, yellow for deteriorating performance, and gray for normal performance. These color codes are calculated by comparing current latency metrics with precomputed baselines derived from the past 30 days of latency data, or any other interval. The visual representation of these metrics allows for an intuitive understanding of network health, enabling quick identification of problem areas. In various embodiments, the nodes 504 and/or the links 502 can be colored based on the various color codes to indicate performance of an ISP or a link between.

To provide a comprehensive understanding of network paths, the system offers detailed metrics such as average latency, median latency, and P99 latency (99th percentile latency), both between different ISPs and within a single ISP. These metrics provide a holistic view of network performance, revealing not only the typical performance but also the worst-case scenarios. By breaking down latency data into these various metrics, network administrators can gain insights into the consistency and reliability of their network connections. The precomputed baselines serve as a reference point, allowing for the computation of severity, which measures the current state against historical performance. This comparison helps teams to identify deviations from normal performance quickly, enabling proactive interventions before issues escalate.

The Multi-Leg Trace Route (MTR) data captured by the system is segmented into multiple legs to pinpoint network degradation or congestion within specific parts of the traffic path. These segments include traffic flowing from the client's egress point to the clouds 120 data centers (Client to DC, where computing devices and DCs are represented as nodes 504 and the connections therebetween are represented as links 502), from the clouds 120 data centers to the applications (DC to Application, where DCs and applications are represented as nodes 504 and the connections therebetween are represented as links 502), and directly from the client's egress point to the applications (Client to Application, where computing devices and applications are represented as nodes 504 and the connections therebetween are represented as links 502). Grouped into 30-minute intervals, these segments are represented in graphs to isolate where problems might lie in the network path, whether closer to the client or towards the application. This detailed segmentation allows for focused troubleshooting on the specific leg where degradation occurs, rather than diagnosing the entire network path. In various embodiments, the dashboard allows for switching between various views, i.e., different segments, for viewing segments of the network.

The client to DC segment helps identify issues that may arise in the initial leg of the journey, where the client device connects to the cloud 120 infrastructure. Problems in this segment could be due to local ISP issues or last-mile connectivity problems. The DC to application segment focuses on the path from the cloud 120 infrastructure to the application servers, highlighting issues that could be related to data center performance, inter-ISP connectivity, or application server availability. The client to application segment provides an end-to-end view, capturing the entire journey of the data from the client to the application, which is essential for understanding the overall user experience. Again, these paths can be visualized by color coded nodes 504 and links 502 as described herein, where clients (computing devices), DCs, and application servers are represented as nodes 504, and the connections therebetween represented as links 502. The various visualizations described herein can be displayed to users/administrators within dedicated dashboards provided by the cloud 120. Again, each node 504 and link 502 can be color coded to indicate an issue with a specific node or a connection between.

This advanced visualization and insight capability enable real-time detection of choke points on the internet globally, allowing networking teams and individuals to facilitate seamless end-to-end internet connectivity for end users. By identifying patterns and potential issues in the network, proactive measures can be taken before these issues impact end users. For instance, recurring latency spikes in a specific region could indicate the need for additional infrastructure or a change in ISP routing policies. Moreover, this solution enhances the ability to manage and optimize network performance by providing real-time insights into network congestion and performance. These insights empower IT teams to make data-driven decisions, whether it's rerouting traffic, upgrading infrastructure, or negotiating better service level agreements with ISPs.

The value of the present systems extend beyond immediate troubleshooting. By continuously monitoring and analyzing network performance, organizations can build a historical dataset that offers strategic insights into long-term trends and patterns. This data can inform capacity planning, infrastructure investments, and risk management strategies. For instance, understanding peak usage times and regional performance variations can help in optimizing resource allocation and ensuring that critical applications remain accessible and performant.

Furthermore, the ability to visualize and analyze network performance at such a granular level fosters better communication and collaboration between different IT and network teams. When everyone has access to the same detailed and accurate data, it becomes easier to coordinate efforts, share insights, and develop comprehensive solutions to complex network challenges. This collaborative approach ensures that all stakeholders are aligned and working towards common goals, ultimately leading to a more resilient and efficient network infrastructure.

In summary, the advanced visualization and analysis capabilities of the present systems provide unparalleled insights into network performance, enabling proactive management and optimization. By leveraging detailed metrics, real-time data, and historical trends collected by the cloud 120, organizations can ensure seamless connectivity, enhance user experience, and support strategic decision-making. This holistic approach to network performance management not only addresses immediate issues but also lays the groundwork for sustained operational excellence and continuous improvement.

### § 6.1 Detecting Problematic Isps

The present disclosure further introduces an innovative method for dynamically detecting and quantifying problematic ISPs along the pathway between employees and essential cloud-based productivity applications such as Salesforce, Microsoft Teams, Zoom, and Outlook. This method leverages large-scale telemetry data, time-series analysis, and advanced machine learning algorithms to identify network anomalies, rank their severity, and provide actionable insights for mitigation.

By harnessing large-scale telemetry data collected, via the cloud 120, from millions of devices globally, this approach offers a comprehensive real-time view of network performance. The telemetry data includes detailed information on network paths, latency, packet loss, and other critical metrics, as described above. By continuously monitoring these metrics, the system can detect subtle changes and emerging patterns that may indicate potential network issues.

Time-series analysis plays a crucial role in understanding the temporal dynamics of network performance. By analyzing historical data and comparing it with real-time metrics, the system can establish baselines and identify deviations that signify anomalies. This temporal perspective allows for the detection of both short-term spikes and long-term trends in network performance, providing a robust framework for anomaly detection.

Advanced machine learning algorithms further enhance the capability to detect and quantify problematic ISPs. These algorithms are trained on vast datasets to recognize complex patterns and correlations that may not be apparent through traditional analysis methods. By applying machine learning models, the system can accurately classify network anomalies, rank their severity based on impact, and predict potential future issues.

Once anomalies are detected, the system ranks their severity, providing a prioritized list of issues that require attention. This ranking is based on various factors, including the magnitude of deviation from the baseline, the number of affected users, and the criticality of the impacted applications. By prioritizing issues, the system ensures that the most significant problems are addressed first, optimizing the overall network performance and user experience.

The actionable insights provided by this approach enable IT and network teams to implement targeted mitigation strategies. These insights include recommendations for rerouting traffic, adjusting network configurations, or collaborating with ISPs to resolve underlying issues. By offering specific and practical guidance, the system empowers teams to take proactive measures, reducing downtime and enhancing the reliability of cloud-based applications.

The present methods dynamically detect issues along major internet pathways between customers and applications hosted on cloud platforms, both SaaS and private, by leveraging large-scale telemetry data. This capability ensures comprehensive monitoring and real-time identification of performance issues, enabling swift and effective responses to maintain optimal connectivity and user experience. The detection process encompasses two primary scenarios including the pathway from the customer to the cloud 120 and then from the cloud 120 to the SaaS application, and the direct pathway from the customer directly to the SaaS application.

To provide actionable insights, the method employs machine learning-based anomaly detection, along with baselines and time-series analysis techniques, to identify disruptions in the ISP network. These advanced analytical tools detect anomalies and rank the severity of the impact, offering quantifiable insights into network outages. By prioritizing issues based on their severity, the method helps IT and network teams focus on the most critical problems first, ensuring efficient resource allocation and faster resolution of network disruptions.

As described, the present systems leverage extensive telemetry data collected by the cloud 120 to monitor and enhance the performance of connections between customers and their SaaS and private applications hosted in the cloud. This telemetry data is gathered through trace probes initiated at regular intervals from the customer's device, for example via the application 110, to a Secure Service Edge (SSE), traversing multiple Autonomous Systems (AS). The collected telemetry includes detailed metrics such as hop-by-hop latency, which measures the time taken for data packets to travel between successive network nodes; packet loss, which calculates the percentage of data packets lost during transmission; and jitter, which measures the variability in packet delay.

To effectively utilize this telemetry data, the system employs a robust method involving several key steps. The process begins with baseline establishment, where time-series analysis is used to establish a performance baseline for a specific “network edge.” A network edge is defined as the connection between two distinct units, such as two routers with unique IP addresses or, at a higher level, between two ASes. The established baseline represents the normal performance metrics, i.e., latency, packet loss, and jitter, under typical operating conditions. For example, the system might learn that the typical latency between an employee's ISP, identified as AS 10001, and Microsoft's cloud services, identified as AS 20002, is 40 ms with minimal packet loss during working hours.

Following the establishment of a baseline, the method involves continuous monitoring and comparison of the current performance data of the network edge against the established baseline. Machine learning algorithms are employed to analyze deviations from the baseline to detect anomalies, which may indicate potential issues such as network congestion, Distributed Denial of Service (DDoS) attacks, or hardware failures. For instance, the system might detect a sudden spike in latency to 100 ms on the connection between an employee's ISP and Zoom's servers, deviating from the normal baseline, suggesting congestion on the ISP network that could potentially affect multiple users.

Detected anomalies are then ranked on a severity scale ranging from 0 to 5. This scale helps categorize the impact of the anomalies: 0 represents normal performance with no detected issues, 1-2 indicates minor issues that may slightly affect performance, 3-4 represents moderate to significant issues impacting performance and user experience, and 5 indicates severe issues causing major disruptions or complete loss of connectivity. In one scenario, an anomaly detected on the path to Salesforce might be ranked as 4, indicating significant packet loss and latency spikes, thereby impairing users'ability to access the CRM platform and delaying business-critical operations.

Finally, the method provides quantifiable insights into network outages by correlating detected anomalies with specific network edges and ranking their severity. These insights enable proactive troubleshooting and resolution of network issues, thereby improving the overall end-user experience and productivity. For example, if the method identifies a recurring packet loss issue between a regional ISP in Europe and Microsoft Teams'servers, IT teams are notified and can prioritize engagement with the ISP to resolve the issue, preventing further impact on employee collaboration.

By dynamically detecting issues within ISPs and utilizing machine learning to rank the severity of their impact, the present systems offer a robust solution for monitoring and improving the reliability of internet pathways between customers and Secure Service Edges (SSEs). This proactive approach ensures that potential disruptions are identified and addressed promptly, thereby maintaining optimal performance and enhancing the user experience.

### § 6.2 Network Traffic Analysis and Visualization Process

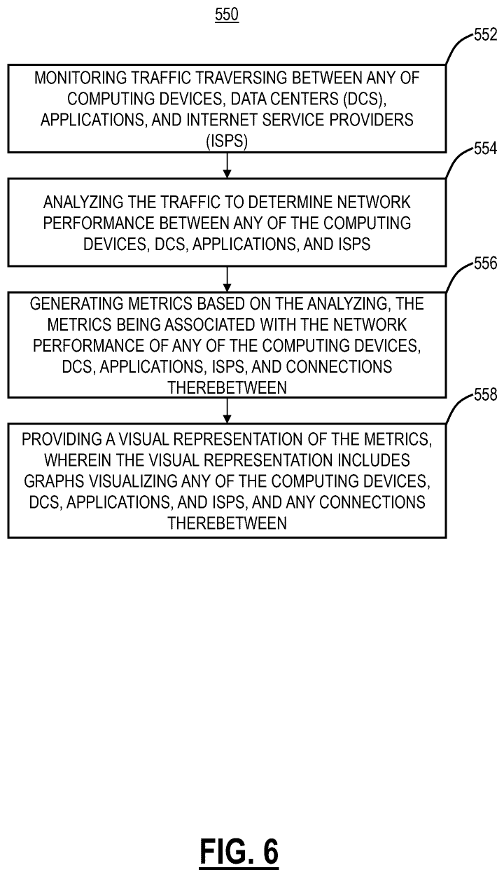

FIG. 6 is a flowchart of a process 550 for providing detailed cloud-level network traffic insights and visualizations. The process 550 can be contemplated as a method having steps, a processing device configured to implement the steps, a cloud-based system configured to implement the steps, and as a non-transitory computer-readable medium storing instructions for programming one or more processors to execute the steps. The process 550 includes monitoring traffic traversing between any of computing devices, Data Centers (DCs), applications, and Internet Service Providers (ISPs) (step 552); analyzing the traffic to determine network performance between any of the computing devices, DCs, applications, and ISPs (step 554); generating metrics based on the analyzing, the metrics being associated with the network performance of any of the computing devices, DCs, applications, ISPs, and connections therebetween (step 556); providing a visual representation of the metrics, wherein the visual representation includes graphs visualizing any of the computing devices, DCs, applications, and ISPs, and any connections therebetween (step 558).

The process 550 can further include wherein the graphs include nodes and links, the nodes representing any of the computing devices, DCs, applications, and ISPs, and the links representing connections therebetween. The nodes and links can be color coded to represent network performance associated with any of the computing devices, DCs, applications, ISPs, and the connections therebetween. The monitoring can include performing traces from a plurality of computing devices associated with a plurality of tenants of the cloud-based system to a plurality of destinations. The analyzing can be performed at a geographical level to determine regional network performance and identify location-specific network metrics. The graphs can include nodes and links, wherein computing devices and DCs are represented as nodes and connections therebetween are represented as links. The graphs can include nodes and links, wherein DCs and applications are represented as nodes and connections therebetween are represented as links. The graphs can include nodes and links, wherein computing devices and applications are represented as nodes and connections therebetween are represented as links. The analyzing can include utilizing one or more machine learning algorithms for detecting problematic ISPs. The steps can further include generating metric baselines for any of the computing devices, DCs, applications, ISPs, and connections therebetween; determining issues in network performance based thereon; and presenting the determined network issues within the visual representation.

### § 7.0 Personalized Customer Impact Reports

Currently, when issues arise within the Cloud 120 SSE or Zero Trust Exchange, trust posts are broadcasted to all customers, regardless of whether they are actually affected or not. This blanket communication approach often results in widespread confusion among the customer base, leading to unnecessary concern and, over time, an erosion of trust. Customers might interpret these general notifications as indicative of broader, more systemic issues, even when the problems might be isolated or specific to certain circumstances. Furthermore, the root causes of these issues can be diverse and multifaceted, originating not just from cloud 120 services but also potentially from ISPs or the customer's own network configurations and equipment, such as misconfigured settings, local Wi-Fi issues, or faulty routers.

To mitigate these challenges and enhance the overall customer experience, the present systems are further adapted to provide personalized customer impact reports. This innovative system leverages detailed data from the digital experience monitoring system to accurately identify the specific origin of network issues. By analyzing a rich set of data points, the system can determine whether a problem stems from the cloud 120 infrastructure, an ISP, or the customer's own environment. This precise identification allows the system to deliver communications exclusively to those customers who are directly impacted by the issues at hand.

This targeted communication approach brings several significant benefits. Firstly, it enhances transparency by ensuring that only relevant information reaches the affected customers, thereby reducing unnecessary noise and confusion. Customers receive clear, pertinent updates that directly relate to their situation, which helps to maintain and even build trust in the reliability and responsiveness of the services offered through the cloud 120. Secondly, it empowers customers to take appropriate, informed action. Depending on the identified source of the issue, customers can troubleshoot their own systems, engage with their ISP for resolution, or coordinate with cloud support for assistance.

By adopting this focused and precise communication strategy, the present systems not only improve the overall customer experience but also facilitate quicker and more effective resolutions to connectivity issues. Customers are no longer left in a state of uncertainty or undue concern. Instead, they receive actionable insights that enable them to address and resolve problems more efficiently.

The present systems effectively address the challenges of traditional network monitoring and communication by leveraging global data collected by the cloud 120. This system provides a multi-faceted approach to ensure that customers receive precise, actionable insights tailored to their specific needs. Generating the impact reports include performing customer-specific impact analysis. This includes data collection where the system collects real-time performance metrics, network path data, and device-specific information that is unique to each customer's environment. This comprehensive data collection allows for an in-depth analysis of network performance on a per-customer basis. Further, precise issue identification includes leveraging this detailed information. By doing so, the system can accurately determine whether network issues originate from the ISP, cloud 120 services, or the customer's own configurations and equipment. This includes identifying problems such as misconfigurations, local Wi-Fi issues, or faulty routers. By pinpointing the exact source of the issue, the system facilitates more efficient and targeted troubleshooting.

Additionally, the system offers tailored communication. This includes selective notifications, where instead of sending broad, blanket notifications to all customers, the system sends trust posts and impact notifications exclusively to those customers who are actually experiencing issues. This targeted approach reduces unnecessary alerts and ensures that only relevant parties are informed. The notifications include specific details about the nature of the issue, the impact level, the number of affected users within the customer's organization, and recommended actions. This level of detail helps customers understand the scope and severity of the problem, enabling them to take informed steps towards resolution.

Even further, the system is adapted to provide guidance and acrtionable recommendations. Based on the identified source of the issue, the system provides customized solutions and steps for mitigation. These actionable recommendations empower customers to address the problem effectively, whether it involves troubleshooting their own systems, engaging with their ISP, or coordinating with cloud 120 support. Equipped with detailed insights, customers can engage more effectively with ISPs to address external issues, resolve internal problems with greater efficiency, or work closely with cloud 120 support for prompt resolution. This enhanced transparency and guidance significantly improves the overall customer experience, fostering trust and ensuring that connectivity issues are resolved swiftly and effectively.

In an example use case, an organization may be experiencing intermittent connectivity issues, and the problem could originate from the ISP, cloud 120 services, or the organization's own network configurations. With traditional approaches, when an issue occurs, a generic trust post is sent to all customers. This blanket notification causes unnecessary concern among those who are not affected by the issue. The organization is unable to determine whether the issue is with the cloud 120, the ISP, or their own systems, leading to confusion and inefficiency. As a result, the organization wastes time and resources investigating all possible sources of the issue without clear guidance, delaying resolution and increasing frustration.

With the present personalized system, the cloud 120 collects comprehensive data on the organization's network performance, user experience, and path analysis. This data-driven approach allows for a thorough examination of the network's behavior and performance metrics. Through this detailed analysis, the cloud 120 determines that the connectivity issue originates from the organization's local network due to a misconfigured router. This precise identification of the problem source directs the organization to the specific area that needs attention. Unlike the traditional approach, only the affected organization receives a trust post. This notification details the issue, specifying that the source of the problem is within their own environment, thereby eliminating unnecessary alerts to unaffected customers. The notification includes an impact assessment, indicating the number of users affected and the severity of the issue. This detailed information helps the organization understand the scope and urgency of the problem.

The notification further provides tailored recommendations to resolve the misconfiguration. These specific instructions guide the organization on how to address the issue effectively. The notification also suggests steps for verifying router settings and provides resources for additional support if needed. This guidance ensures that the organization has the tools and information necessary to fix the problem quickly.

Armed with clear guidance, the organization addresses the internal issue promptly, restoring normal connectivity. This quick resolution minimizes downtime and disruption. By accurately identifying the source of the issue, the organization avoids unnecessary escalation to ISPs or the cloud 120 support, saving valuable time and resources. Unaffected customers continue their operations uninterrupted, maintaining their trust in the cloud 120 services and communications. This targeted and efficient approach ensures that only those impacted are notified, preserving confidence in the reliability of the service.

The system utilizes advanced analytics and ML techniques to deliver precise, customer-specific insights into network issues. By harnessing the rich data collected by the cloud 120, the system can accurately identify which customers are affected and determine the root cause of the issue. This cutting-edge approach allows the system to discern whether the problem originates from the ISP, cloud 120 services, or the customer's own environment, such as misconfigurations or hardware problems.

The system employs sophisticated analytics and machine learning algorithms to process and interpret vast amounts of network performance data. These advanced techniques enable the system to detect patterns and anomalies that may indicate underlying issues. By continuously learning from new data, the ML models improve over time, enhancing their ability to accurately pinpoint the source of network problems.

As described herein, the cloud 120 collects comprehensive data on network performance, user experience, and path analysis across various components of the network for a plurality of tenants. This includes metrics such as latency, packet loss, and device-specific information. The extensive dataset provides a holistic view of the network, enabling the system to analyze performance at multiple levels and identify deviations from normal behavior. Using the detailed data and insights generated by the advanced analytics and ML techniques, the system delivers precise, customer-specific information about network issues. This ensures that each customer receives relevant and actionable insights tailored to their unique environment. The system can accurately identify which customers are experiencing issues, preventing unnecessary alerts to unaffected users and reducing overall noise.

Key features of the present systems include dynamic baseline modeling, multidimensional root cause analysis, and intelligent impact assessment. Dynamic baseline modeling includes per-customer performance profiles, where the system creates individualized performance baselines for each customer by analyzing historical data on key performance indicators (KPIs) such as network latency, throughput, and packet loss. This ensures that each customer's unique network behavior is understood and accounted for. The system employs adaptive thresholds that adjust based on the normal performance variations specific to each customer's environment. This dynamic approach allows for more accurate and relevant performance monitoring. Further, by continuously comparing real-time data against these dynamic baselines, the system can detect deviations immediately. This real-time anomaly detection capability allows for the swift identification of potential issues, enabling quick responses to emerging problems.

Multidimensional root cause analysis includes correlating data from various layers, including network paths, application performance, device health, and user experience metrics. This comprehensive data integration allows for precise pinpointing of the source of issues, whether they stem from network infrastructure, application performance, or user devices. The system utilizes both supervised and unsupervised learning models trained on vast datasets to identify patterns indicative of specific issues, such as ISP congestion or device misconfigurations. These advanced ML algorithms enhance the system's ability to diagnose complex problems accurately. By recognizing early warning signs through predictive analytics, the system can anticipate potential future issues. This foresight enables proactive measures to be taken, preventing significant impacts before they occur.

Finally, intelligent impact assessment includes user impact estimation, where the system calculates the number of users affected within an organization by analyzing login patterns, application usage, and network connectivity data. This user impact estimation provides a clear picture of how widespread an issue is within the customer's environment. Beyond technical metrics, the system assesses the potential impact on critical business operations by identifying affected applications and services essential to the customer's operations. This business-centric analysis ensures that the most critical issues are prioritized. Further, the system assigns impact levels (Low, Medium, High, Critical) based on both technical metrics and the specific business context of each customer. This customization ensures that the severity of issues is accurately reflected in terms of their potential business impact, facilitating appropriate prioritization and response.

### § 8.0 Dynamic Traffic Routing

The present disclosure further provides systems and methods for monitoring network metrics and automatically switching a user to a more performant data center using both real-time and historical baseline network data. In today's digital landscape, maintaining consistent and high-quality internet performance is critical for businesses. However, network congestion and chokepoints can significantly degrade the user experience, making it essential to address these issues promptly. Traditional static routing techniques often prove inadequate for managing dynamic network conditions, resulting in slower response times and increased downtime. While application 110 configuration allows IT administrators to specify which data center to connect to, this process remains manual if a switch to another data center is required.

This manual approach poses a significant challenge for network administrators who must identify and mitigate congestion points, often leading to delayed actions and prolonged network issues. One of the most common solutions employed by the ops team to resolve these issues is to switch a set of users experiencing problems from one data center to another. However, this method is reactive rather than proactive. Companies, therefore, need a solution that can adapt in real time to changing network conditions, ensuring seamless and uninterrupted connectivity. This capability would enable businesses to maintain optimal performance and enhance the overall user experience, even in the face of fluctuating network demands.

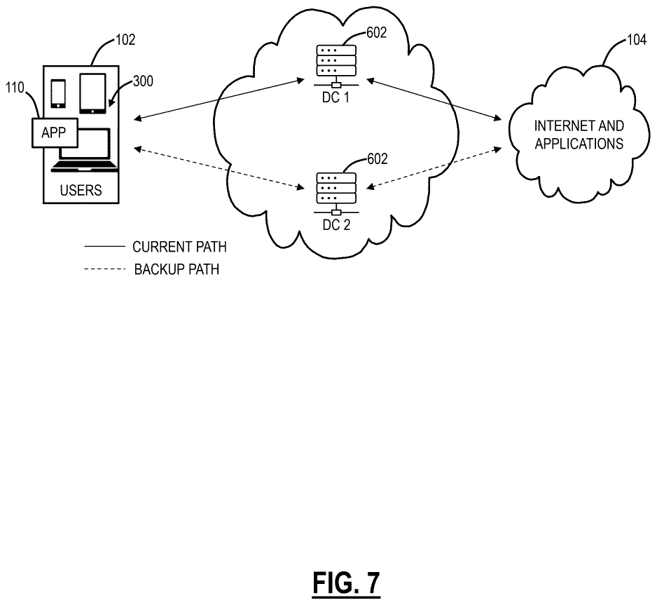

FIG. 7 is a flow diagram of the dynamic traffic routing. Based on the capability of the application 110 to switch between data centers (DCs) 602, a system is introduced that automates this process to ensure optimal performance. To achieve this, the application 110 is adapted to periodically monitor its connectivity to a set of available data centers 602, which can be pre-selected by IT administrators. This monitoring generates real-time connectivity information regarding the performance of each of the DCs, providing the first set of usable data. At any given moment, there will be a “best performing” DC 602 from the available list based on this real-time data, and based thereon, the application 110 can select to switch to the best performing DC 602.

To make more informed decisions regarding data center 602 switching, the system can augment real-time connectivity information with the historical performance data of each data center 602. For instance, in a hypothetical scenario, if the system knows, based on historical data, that around 9 AM PST every day, the San Jose data center 602 tends to become congested with most users in California configured to connect there, users might benefit from switching to the San Francisco data center 602. If this historical congestion information is known ahead of time, the initial poor performance at San Jose can be completely avoided by connecting users to San Fransisco from the beginning.

To implement this solution, various embodiments use a time-series analysis model or a statistical model to create performance baselines by the hour for every day of the week. These baselines are dynamically updated with new real-time data. Based on the scores for each path, i.e. comparing baselines to real-time data, the system can then select the best option using one of several algorithms suited for this problem. This approach ensures that the application 110 can proactively manage DCs 602 connectivity, providing seamless and uninterrupted network performance, and significantly enhancing the user experience.

In the context of evaluating network performance, path scoring involves leveraging probe information from the client or user to the application. This process can be broken down into distinct segments known as “legs”. A leg is defined as the connection between two major points of interconnection along the probe's entire journey. For instance, the first leg might be the connection from the user to a data center 602, while the second leg could be from the data center 602 to the application. In cases where there are additional significant junctions such as a broker or connector, the path would encompass more legs.

There are two primary methods to score a user's experience including utilizing metrics obtained from each leg individually or using the combined data across all legs. Each approach has its own set of advantages and disadvantages.

When the systems focus solely on the metrics from each leg, they might overlook the overall user experience. For example, a poorly performing router on the first leg may introduce additional latency. However, this increase might be negligible, such as a mere 2% increase in total latency, when viewed in the context of the entire path's performance. On the other hand, if the systems consider only the end-to-end metrics, they might encounter the opposite issue. For instance, a bad router causing significant latency on the first leg might be masked by the overall high latency of the application, rendering the increase less noticeable in the end-to-end score.

To achieve a comprehensive evaluation, it is beneficial to score both the individual legs and the entire path. This dual approach allows the system to examine the granular details of each segment while also considering the overall user experience, thereby enabling a more effective and informed judgment. The scoring process for evaluating network performance involves two critical steps of baselining and score assignment.

Baselining is the first step, where the systems analyze the last seven days', or other interval, worth of data for each metric related to a particular leg or the entire end-to-end path. Given the extensive deployment scale of the cloud 120, the systems have visibility into multiple users taking the same path, which ensures the reliability of the statistical estimates. During this phase, the systems assign a baseline value for each metric using statistical measures. For instance, the p50 (median) value can be chosen as the baseline.

Additionally, the systems determine a deviation value by analyzing other percentile values of the metric to understand the variability or spread of the score along the path. This process is repeated across all relevant metrics to establish a comprehensive baseline and deviation profile.

Once the baseline and deviation values are established for each metric, both for individual legs and the entire path, the systems proceed to score incoming probes. This is done by comparing the probe's metric values against the baseline and noting how many deviations away they are. For example, if the baseline score is set at 80, a latency value that is one deviation higher might be assigned a score of 70 (since increased latency indicates poorer performance), while a latency value one deviation lower could be scored at 90.

After determining the individual scores for each metric, the systems integrate them into a single score for the respective leg or the entire path. This integration is achieved using a weighted average, where each metric is assigned a specific weight based on its importance. This comprehensive scoring system allows the systems to effectively assess and compare the performance of different network paths and segments, providing a nuanced understanding of user experience.

Path switching is a critical component of network optimization, where the systems continually monitor the performance scores of each available path from the client to the destination. Since multiple data streams are received, one for each DC 602, the systems have several scores to evaluate. Deciding when and how to switch paths is a complex process, requiring the evaluation of multiple algorithms to determine the best approach for any given scenario.

Ignoring the simplest method of switching paths whenever a better score is detected, the systems can employ more sophisticated strategies to ensure optimal path selection. These strategies include the following.

Hysteresis-based switching: This method introduces a deliberate delay in path switching to avoid frequent changes. A threshold is set that must be crossed before switching to a better-scoring path. This helps mitigate the impact of transient score fluctuations.

Moving average or score smoothing: Rather than relying on raw score values, this approach uses a moving average or exponential smoothing of the scores. By smoothing out the data, the likelihood of switching paths due to minor and temporary score variations is mitigated, leading to more stable path selection.

Sticky routing with a timer: Similar to hysteresis-based switching, this method involves setting a time-based threshold. Once a path is chosen, it remains “sticky” for a predetermined duration, preventing frequent switches even if a better path is identified during this period. This time-based stickiness ensures continuity and reduces the potential for disruption.

Probabilistic switching: In this approach, the probability of switching paths increases as the score of an alternative path improves. By adjusting the likelihood of switching based on score trends, the systems can dynamically adapt to changing network conditions while avoiding abrupt changes.

Multi-armed bandit approaches: This advanced strategy involves balancing exploration and exploitation across the available paths. Algorithms such as Thompson Sampling, which models a probability distribution on the expected rewards for each path, can be used to dynamically select the best path. This method allows for ongoing learning and adaptation to optimize path selection over time.

By employing these sophisticated path switching techniques, network performance remains robust and efficient, dynamically adjusting to changing conditions while minimizing disruptions.

### § 8.1 Dynamic Traffic Routing Process

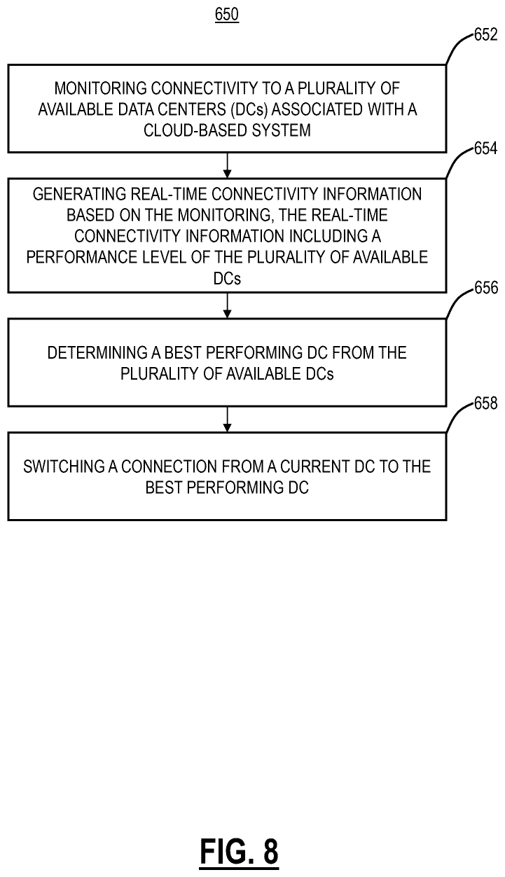

FIG. 8 is a flowchart of a process 650 for dynamic traffic routing. The process 650 can be contemplated as a method having steps, a processing device configured to implement the steps, a cloud-based system configured to implement the steps, and as a non-transitory computer-readable medium storing instructions for programming one or more processors to execute the steps. The process 650 includes monitoring connectivity to a plurality of available Data Centers (DCs) associated with a cloud-based system (step 652); generating real-time connectivity information based on the monitoring, the real-time connectivity information including a performance level of the plurality of available DCs (step 654); determining a best performing DC from the plurality of available DCs (step 656); and switching a connection from a current DC to the best performing DC (step 658).

The process 650 can further include wherein the monitoring, generating, determining, and switching are performed by an agent application on a computing device, and wherein the switching includes forwarding traffic from the computing device to the cloud-based system via the best performing DC. The determining can include augmenting real-time connectivity information with historical performance data of each DC. The steps can include generating performance baselines by the hour for every day of the week for each of the plurality of available DCs. The steps can include dynamically updating the performance baselines based on real-time data. Determining a best performing DC can be based on the performance baselines and real-time connectivity information of the plurality of available DCs. The switching can include delaying the switching by a preconfigured interval to mitigate the impact of transient connection performance fluctuations. The switching can include remaining connected to a DC for a predetermined duration, thereby preventing frequent switches even if a better path is identified during this period.

### § 9.0 Network Health Dashboard

Ensuring optimal internet performance is crucial for organizations and their users'satisfaction. However, selecting the best ISP remains a significant challenge due to the lack of personalized, geolocation-specific data. To address this issue, an advanced dashboard that equips organizations with real-time updates on network health and offers a comprehensive comparison of ISPs based on geolocation is introduced. By leveraging this sophisticated tool, organizations can make well-informed decisions, ensuring they achieve the highest possible internet service quality tailored to their specific needs. This innovative solution not only enhances efficiency but also empowers organizations to maintain a competitive edge in an increasingly connected world.

The present systems offer several key features designed to enhance network performance management for organizations. Firstly, they provide a dashboard that delivers real-time health updates of the network across the geolocations of all customer devices. This allows for immediate visibility into network status and performance, ensuring any issues can be promptly identified and addressed. Secondly, the dashboard facilitates a personalized evaluation of ISPs based on geolocation, enabling organizations to select the optimal internet service provider tailored to their specific needs. This ensures that users receive the best possible internet service, enhancing overall satisfaction and productivity. Lastly, the dashboard includes a feature for temporal performance comparison, which effectively differentiates between normal network behaviors and performance issues. This capability helps in identifying and resolving anomalies quickly, maintaining consistent and reliable network performance. Together, these features empower organizations to make informed decisions and maintain robust network health.

In today's market, there is a noticeable absence of sophisticated dashboards capable of providing granular and personalized network path insights. Given that internet connectivity is a mission-critical service, it must be continuously optimized to ensure peak performance and reliability. Organizations heavily depend on stable and efficient internet connections to support their operations, communication, and service delivery. The lack of real-time monitoring and comparative analysis tools significantly hampers their ability to proactively identify and resolve issues.

The proposed dashboard is specifically designed to address these gaps by offering real-time health updates for the network across all customer devices and various geolocations. This ensures that organizations always have the most current information at their fingertips. Consequently, IT teams can quickly detect and resolve issues, thereby minimizing downtime and optimizing network performance.

Traditional methods of selecting an ISP fall short as they do not provide real-time insights into network health across different geolocations, nor do they allow for personalized comparisons. This makes it difficult for organizations to make informed decisions that could enhance their internet performance. The most popular ISP in a geolocation may not necessarily be the best option for every organization or user. Conversely, not being part of the most popular ISP might mean missing out on potentially better service. Without a clear understanding of how their current ISP stacks up against others available in their area, organizations may miss opportunities to switch to more efficient options.

The proposed comprehensive dashboard evaluates all the ISPs used by an organization, as well as all the ISPs operating within a specific geolocation. This enables a personalized evaluation of ISPs based on geolocation, delivering a thorough comparison and aiding organizations and their users in making informed decisions when it comes to choosing the right ISP. This ensures that end users receive the best possible internet service, tailored to their specific needs.

In complex network environments, identifying and diagnosing performance issues is a significant challenge due to the sheer volume of data and the variability in normal network behavior. Traditional monitoring tools often struggle to differentiate between routine fluctuations and actual performance incidents, leading to either missed issues or false positives. This ambiguity can result in prolonged downtime, inefficient troubleshooting, and a general lack of confidence in network reliability.

The proposed dashboard addresses these challenges by offering temporal performance comparisons, enabling network administrators to effectively distinguish between normal network behavior and genuine performance issues. By leveraging time-based analytics, the dashboard provides clear visualizations and insights, facilitating quicker identification and resolution of incidents. This approach is particularly beneficial for engineers and operators, allowing them to compare loss values in ISP paths and differentiate between ICMP de-prioritization and actual packet loss. Deviations from this established “baseline” of loss due to de-prioritization help engineers identify any real losses. This method not only enhances the accuracy of issue detection but also reduces downtime and improves overall network reliability and performance management.

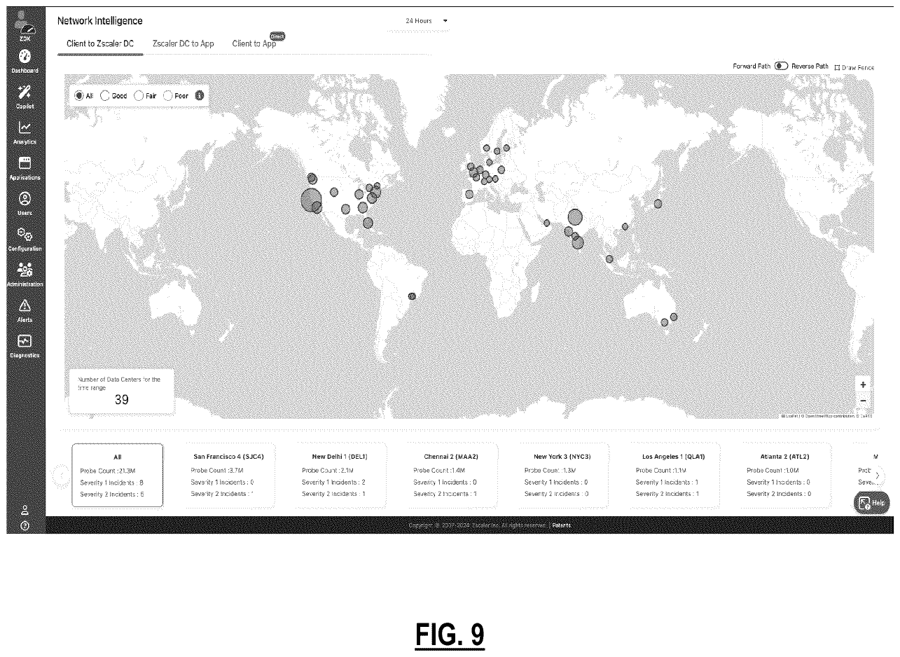

FIG. 9 is a screenshot of the dashboard displaying a comprehensive view of network performance across different regions. The traces captured by the cloud 120 include detailed latency and loss metrics at each hop level, facilitating a granular analysis to identify any degradation in the internet network. This hop-level analysis is then aggregated by geolocation, providing a comprehensive view of network performance across different regions. This geo-based aggregation enables the identification of patterns or recurring issues that may be affecting specific areas. By correlating hop-level data with geographical insights, the Network Intelligence Dashboard empowers customers to efficiently pinpoint and address the root causes of network degradation. Additionally, the dashboard aids in proactive network management, ensuring optimal performance and reliability for end users across various locations. This holistic approach not only enhances troubleshooting accuracy but also supports strategic decision-making to maintain a robust and reliable network infrastructure.

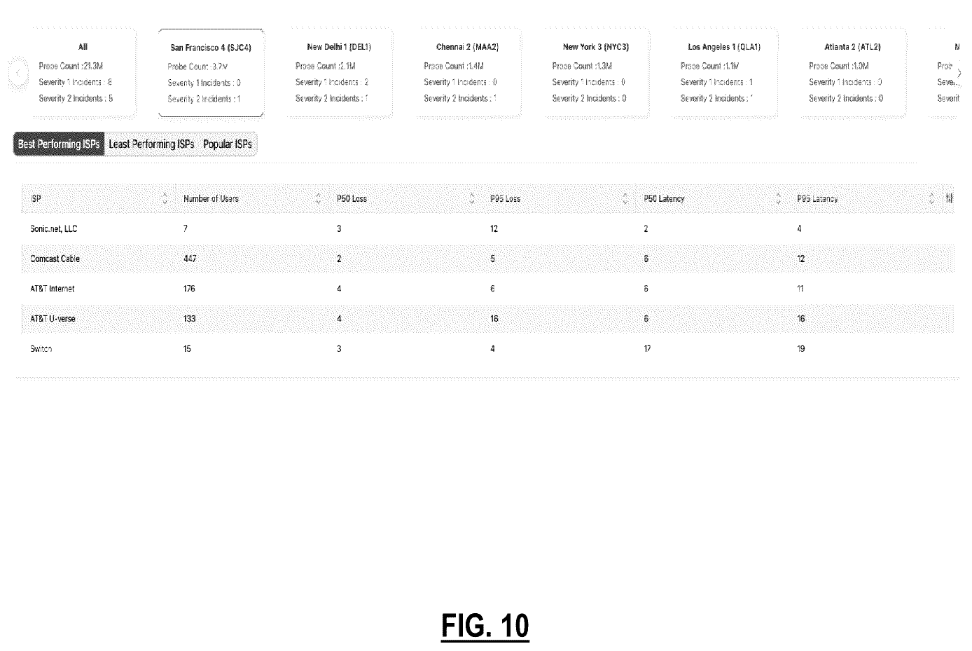

The cloud 120 detects the egress point of every probe, enabling the identification of the ISP used by each device. By grouping these egress points across different geographic locations, the system can provide a comprehensive comparison of the ISPs available in those areas. Customers can leverage this valuable information to decide whether to switch ISPs or recommend alternative ISPs to their users for better internet connectivity and performance. The primary metrics used to categorize ‘Best Performing ISPs’ and ‘Least Performing ISPs’ are latency and loss, as they are crucial indicators of internet performance. By computing the 50th percentile of latency and loss for each ISP, we focus on median performance, thereby eliminating any outliers. This approach ensures a more accurate and representative assessment of ISP performance. This data-driven methodology empowers customers to make informed decisions, optimizing their internet service for enhanced reliability and efficiency. FIG. 10 is a screenshot of the dashboard displaying ISP performance rankings.

This data-driven approach enables decisive decision-making regarding internet service providers, ensuring optimal network reliability and efficiency. Ultimately, the cloud 120 helps organizations enhance their overall network performance by leveraging detailed insights into ISP performance. By providing accurate, median-based assessments, the cloud 120 allows organizations to make informed choices that improve connectivity and service quality, leading to better operational outcomes and user satisfaction.

In various embodiments, the systems retain analyzed historical data for over 60 days to facilitate comprehensive temporal analysis, which is essential for making accurate comparisons. This extended data retention period allows the systems to distinguish between normal network behaviors and anomalies. By examining data across various time frames, such as the past week or the past 15 days, and comparing it with current metrics, the systems can effectively assess changes in network behavior.

For example, if a consistent 10% packet loss over the past 3-4 weeks on the same ISP path to data center 602 is observed, this pattern can be considered expected behavior. By recognizing and understanding these patterns, the systems can better anticipate and respond to network issues. This capability enables proactive management of network performance, ensuring that any deviations from the norm are promptly addressed.

Comparing historical and current data allows the fine-tuning of network configurations for optimal performance. These insights are invaluable for driving informed decision-making, contributing to the robustness and reliability of our network infrastructure. By leveraging this detailed historical analysis, the systems can ensure a more stable and efficient internet experience for end users, ultimately enhancing overall network reliability and performance.

### § 10.0 ISP Ranking

The present disclosure further provides systems and methods that leverage advanced Machine Learning (ML) algorithms to track and evaluate the performance of Internet Service Providers (ISPs) across various geographical levels, ranging from local to global scales. By systematically collecting and analyzing key network metrics such as latency, bandwidth, packet loss, and uptime, the systems provide a comprehensive assessment of ISP performance.

With millions of devices connecting to the internet daily, their traffic traverses multiple Autonomous Systems (AS) in route to their final destinations. This complex and dynamic nature of internet routing often leads to common issues. Congestion occurs when high traffic loads on specific network paths cause delays and packet loss. Distributed Denial of Service (DDoS) attacks involve malicious attempts to overwhelm network resources, resulting in significant service disruptions. Hardware failures in physical infrastructure can lead to unexpected connectivity issues. Routing misconfigurations, due to incorrect policies or errors, may result in suboptimal path selections and connectivity disruptions. Furthermore, peering disputes between network operators can result in partial or complete loss of connectivity between certain regions.

ISPs are categorized into three tiers based on their network reach and peering arrangements. Tier 1 ISPs are the backbone providers of the internet, often spanning continents and peering with each other without paying for transit. Tier 2 ISPs connect with both Tier 1 ISPs and other Tier 2 ISPs to offer internet connectivity, engaging in both peering and purchasing transit. Tier 3 ISPs purchase internet access from Tier 1 and Tier 2 ISPs and retail it to end customers.

Analyzing ISP performance at different geographic levels is crucial due to the localized nature of network issues. Network problems often manifest more prominently in specific locations rather than uniformly across the entire network. By understanding these localized issues, detailed and accurate “outage maps” can be created. Outages and performance degradations can vary significantly across different regions due to several factors. Localized events such as hardware failures, natural disasters, or targeted DDoS attacks can impact specific areas. Infrastructure variability means that the quality and capacity of ISP infrastructure can differ widely from one location to another. Regional peering agreements and routing policies can also affect ISP performance in various regions. Lastly, user density in areas with higher concentrations of users can lead to more congestion and performance variability.

By evaluating ISPs at a granular geographic level, the present systems can identify specific regions where an ISP excels or underperforms. This localized assessment is essential for targeted improvements and investments. A ranking system is paramount as it provides consumers with objective data to compare ISPs, helping them make informed choices and avoid persistent connectivity issues. Globally, such a ranking system identifies the most reliable and efficient ISPs, facilitating insightful decisions by stakeholders. Localized rankings are equally important as they highlight performance differences within specific regions, directing attention to where improvements are most needed. The combination of global and localized insights offers a comprehensive view of ISP performance across different scales.

In various embodiments, the process begins by aggregating extensive data from multiple sources, ensuring a robust dataset that accurately reflects network conditions. ML models are then employed to process this data, identifying patterns and trends that may not be immediately apparent through traditional analysis methods. These models are adept at handling large volumes of data and can efficiently parse through it to extract meaningful insights.

Once the data has been analyzed, ISPs are ranked from best to worst based on their performance metrics. This ranking is dynamic and can be adjusted in real-time as new data is ingested, providing up-to-date evaluations of ISP performance. The system can adapt to various geographical contexts, offering granular insights that are specific to regions, cities, or even neighborhoods.

The ML-based ranking method not only highlights the top-performing ISPs but also identifies areas where providers may need improvement. This information is invaluable for consumers seeking reliable internet services and for ISPs aiming to enhance their offerings. By providing a transparent and data-driven evaluation of ISP performance, this method fosters a competitive environment that ultimately benefits end-users with better service quality.

The methodology for evaluating ISP performance encompasses several key steps, each designed to systematically gather, analyze, and visualize network data to provide comprehensive insights into ISP reliability and efficiency. The process begins with the extensive collection of trace data from millions of global locations. This data captures the performance characteristics of ISPs by detailing the path that data packets take across various networks and Autonomous Systems (AS). Once the data is collected, it is evaluated using key network metrics such as latency, packet loss, jitter, and throughput. These metrics provide a foundational understanding of the network's performance and the quality of service provided by different ISPs. Advanced ML algorithms are then applied to the collected data. These algorithms are instrumental in identifying patterns and anomalies in ISP performance, allowing for a nuanced and accurate analysis that goes beyond simple statistical evaluation.

Based on the analyzed metrics, ISPs are ranked according to their performance. This ranking considers multiple factors such as reliability, speed, consistency, outage occurrences and durations, and can be broken down by various geographical levels to provide a more detailed view. To make the data accessible and actionable, visual representations such as heat maps and outage maps are created. These visual tools offer a clear and intuitive view of ISP performance across different regions, highlighting areas of excellence and concern. As described, customized dashboards can be provided to tenants of the cloud 120, where recommended and ranked ISPs can be provided for tenants specific office locations, allowing them to make informed decisions even if they have geographically distributed offices.

Network monitoring solutions, such as the clouds 120 digital experience monitoring platform, play a crucial role in this methodology by collecting extensive telemetry data at a global level from millions of endpoints. This data is gathered through the connection between a customer and a Secure Service Edge (SSE). Trace probes, run at regular intervals from the customer's devices to the SSE, traverse multiple ASes and collect detailed metrics such as hop-by-hop latency, packet loss, and jitter.

IP geolocation is a challenging aspect due to the inherent difficulty in mapping IP addresses directly to physical locations. However, several strategies can be employed to approximate geolocations with varying degrees of accuracy. For example, the system can utilize pre-existing databases, such as MaxMind, that map IP addresses to geolocations with a certain level of accuracy. Additionally, the system can run probes from various global vantage points to all IPs on the list and assigning the closest vantage point location and radius as the IP's location and accuracy. Once the IP addresses and their corresponding locations are determined, the clouds 120 extensive probe data is used to construct a graph of the internet. In this graph, each IP address acts as a node, and each connection between two IP addresses is an edge. The performance metrics'differentials are calculated for each edge, and plotting this data over time results in a time series for each metric and edge.

This time series data forms the dataset for ML algorithms to assess ISP performance. There are two primary considerations for ranking ISP performance. The first consideration includes latency comparison, including evaluating how different latencies appear when reaching a particular destination through different ISPs from the same geolocation. This involves comparing cloud 120 users from the same location with probes configured to the same destination but using different ISPs. The second consideration includes outage frequency which includes assessing the frequency of outages experienced by an ISP. Frequent disruptions negatively impact an ISP's ranking. Anomaly detection ML techniques are used to identify disruption metrics for an ISP, based on data from all cloud 120 users passing through that ISP.

By meticulously following this methodology, ISPs can be accurately ranked, providing valuable insights for consumers and stakeholders to make informed decisions about internet service providers.

### § 10.1 ISP Ranking Dashboard Process

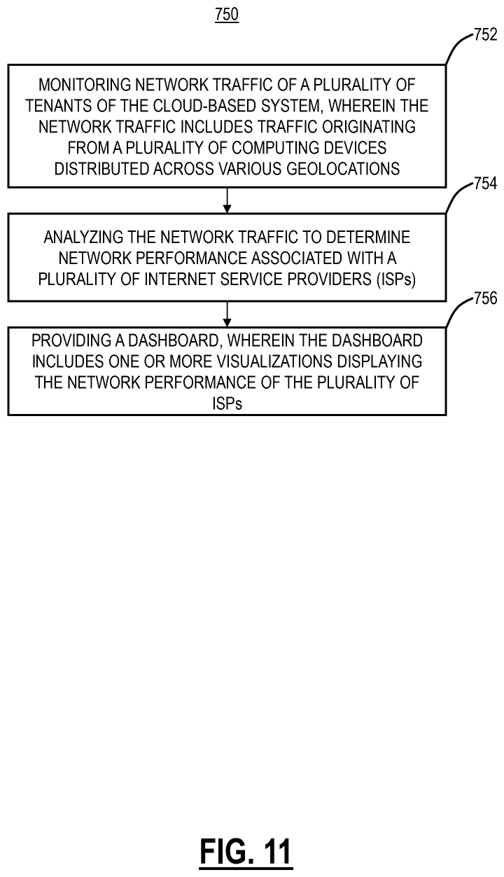

FIG. 11 is a flowchart of a process 750 for providing an ISP ranking dashboard. The process 750 can be contemplated as a method having steps, a processing device configured to implement the steps, a cloud-based system configured to implement the steps, and as a non-transitory computer-readable medium storing instructions for programming one or more processors to execute the steps. The process 750 includes monitoring network traffic of a plurality of tenants of the cloud-based system, wherein the network traffic includes traffic originating from a plurality of computing devices distributed across various geolocations (step 752); analyzing the network traffic to determine network performance associated with a plurality of Internet Service Providers (ISPs) (step 754); and providing a dashboard, wherein the dashboard includes one or more visualizations displaying the network performance of the plurality of ISPs (step 756).

The process 750 further includes wherein the one or more visualizations include network performance metrics associated with ISPs operating within a specific geolocation. The providing can include providing each of the plurality of tenants with a customized dashboard based on geolocation. The steps can include identifying an ISP used by each of the plurality of computing devices; grouping the plurality of ISPs across different geographic locations based thereon; and providing, within the dashboard, a comparison of ISPs available in specific geolocations. The dashboard can include ISP performance rankings for specific geolocations. ISPs can be ranked based on any of reliability, speed, consistency, outage occurrences, and outage durations determined from the monitoring and analyzing. The dashboard can include ISP rankings for various geolocations based on a tenant's office locations.

### § 11.0 Processing Circuitry and Non-transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 12.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method comprising steps of:
monitoring connectivity to a plurality of available Data Centers (DCs) associated with a cloud-based system;
generating real-time connectivity information based on the monitoring, the real-time connectivity information including a performance level of the plurality of available DCs;
determining a best performing DC from the plurality of available DCs; and
switching a connection from a current DC to the best performing DC.

2. The method of claim 1, wherein the monitoring, generating, determining, and switching are performed by an agent application on a computing device, and wherein the switching includes forwarding traffic from the computing device to the cloud-based system via the best performing DC.

3. The method of claim 1, wherein the determining includes augmenting real-time connectivity information with historical performance data of each DC.

4. The method of claim 1, wherein the steps include generating performance baselines by the hour for every day of the week for each of the plurality of available DCs.

5. The method of claim 4, wherein the steps include dynamically updating the performance baselines based on real-time data.

6. The method of claim 4, wherein determining a best performing DC is based on the performance baselines and real-time connectivity information of the plurality of available DCs.

7. The method of claim 1, wherein the switching includes delaying the switching by a preconfigured interval to mitigate the impact of transient connection performance fluctuations.

8. The method of claim 1, wherein the switching includes remaining connected to a DC for a predetermined duration, thereby preventing frequent switches even if a better path is identified during this period.

9. A non-transitory computer-readable medium comprising instructions that, when executed, cause one or more processors to perform steps of:
monitoring connectivity to a plurality of available Data Centers (DCs) associated with a cloud-based system;
generating real-time connectivity information based on the monitoring, the real-time connectivity information including a performance level of the plurality of available DCs;
determining a best performing DC from the plurality of available DCs; and
switching a connection from a current DC to the best performing DC.

10. The non-transitory computer-readable medium of claim 9, wherein the monitoring, generating, determining, and switching are performed by an agent application on a computing device, and wherein the switching includes forwarding traffic from the computing device to the cloud-based system via the best performing DC.

11. The non-transitory computer-readable medium of claim 9, wherein the determining includes augmenting real-time connectivity information with historical performance data of each DC.

12. The non-transitory computer-readable medium of claim 9, wherein the steps include generating performance baselines by the hour for every day of the week for each of the plurality of available DCs.

13. The non-transitory computer-readable medium of claim 12, wherein the steps include dynamically updating the performance baselines based on real-time data.

14. The non-transitory computer-readable medium of claim 12, wherein determining a best performing DC is based on the performance baselines and real-time connectivity information of the plurality of available DCs.

15. The non-transitory computer-readable medium of claim 9, wherein the switching includes delaying the switching by a preconfigured interval to mitigate the impact of transient connection performance fluctuations.

16. The non-transitory computer-readable medium of claim 9, wherein the switching includes remaining connected to a DC for a predetermined duration, thereby preventing frequent switches even if a better path is identified during this period.

17. A computing device comprising:
one or more processors; and
memory storing computer-executable instructions that, when executed, cause the one or more processors to:
monitor connectivity to a plurality of available Data Centers (DCs) associated with a cloud-based system;
generate real-time connectivity information based on the monitoring, the real-time connectivity information including a performance level of the plurality of available DCs;
determine a best performing DC from the plurality of available DCs; and
switch a connection from a current DC to the best performing DC.

18. The computing device of claim 17, wherein the monitoring, generating, determining, and switching are performed by an agent application on the computing device, and wherein the switching includes forwarding traffic from the computing device to the cloud-based system via the best performing DC.

19. The computing device of claim 17, wherein the determining includes augmenting real-time connectivity information with historical performance data of each DC.

20. The computing device of claim 17, wherein the instructions further cause the one or more processors to generate performance baselines by the hour for every day of the week for each of the plurality of available DCs, and determine a best performing DC based thereon.
